(19) United States
(12) Patent Application Publication
(10) Pub. No.: US 2008/0281715 A1
(43) Pub. Date: Nov. 13, 2008

(54) METHOD OF DESIGNING A SURFBOARD OR THE LIKE

(76) Inventors: JOHNATHAN STILLMAN, Dana Point, CA (US); Steven Bolgiano, Willards, MD (US); Juraj Benadik, Prievidza (SK); Stuart Krupoff, Trabuco Canyon, CA (US); Chris Reinhard, Mission Viejo, CA (US)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 11/747,151

(22) Filed: May 10, 2007

(51) Int. Cl. G06Q 30/00

(52) U.S. Cl. 705/26

(57) ABSTRACT

An internet enabled method for designing and ordering a surfboard blank includes hosting on a program internet information service, a website, capable of supporting an interactive procedure and receiving from a web browser an account number request. Account number is assigned in response to the request and upon receipt of the account number by the website, a listing of surfboard blanks is offered for modification along with software. Upon receiving modification instruction for a selected surfboard blank, the modification instruction is associated with the account number and following receipt of an order from an authorized customer for a surfboard blank modified in accordance with modification instruction producing a surfboard blank.

The present invention relates to surfboards and is more particularly directed to an internet enabled method for designing and ordering a surfboard blank.

Surfboards are typically fabricated with a polyurethane foam core, or the like, known as a “blank” which is cut in the general shape of the board. Shaping is then performed on the blank by trimming edges and carving curved portions in the blank. Thereafter, the blank is wrapped with fiberglass and sanded and painted with a resin gloss material.

The “rocker” of a surf blank is the curved of the board that is evident when viewing the board's side profile.

It is desirable to modify this curve, or rocker, to achieve a variety of performance results in a finished surfboard.

The present invention provides for an online software tool that allows the user to custom design surfboard blanks including, but not limited to, customizing rockers for a selected surf blank for subsequent ordering of the blank. The custom design can then be translated into the proper code to run on a computer-numerically-controlled “CNC” router for the fabrication of a surfboard blank with a custom rocker.

### SUMMARY OF THE INVENTION

An internet enabled method in accordance with the present invention for designing and ordering a surfboard blank generally includes hosting on a programmed internet information surface, a website capable of supporting an interactive procedure, receiving from a web browser an account number request, and assigning an account number, in response to the request, for permitting access to surfboard design software.

Thereafter, upon receipt of the account number by the website, providing a listing of surfboard blanks offered from modification and receiving modification instruction for a selected surfboard blank.

The method further includes associating and storing the modification instruction for the selected surfboard blank with the assigned account number and thereafter receiving an order from an authorized customer for a surfboard blank modified in accordance with the modification instruction stored with the account number.

In one embodiment, the account number request is received from a non-authorized customer with a browser and further includes communication of the account number from a non-authorized customer to the authorized customer.

More particularly, the step of providing a listing of surfboard blanks may include a listing of board blanks of various surfboard blank manufacturers.

The method may further include receiving additional instruction for modifying the stored modification instruction and storing the further modified instructions with the assigned account number.

Alternatively, in accordance with the present invention, an internet enabled method for designing and ordering a surfboard blank includes hosting on a programmed internet information service, a website capable of supporting an interactive procedure and receiving from a web browser an account number request and assigning an account number, and responds to the request for permitting access to surfboard design software.

Upon receipt of the account number by a website, access to the surfboard design software is provided and upon receiving custom surfboard blank design instruction associated and storing the design instruction with the assigned account number.

This method differs from the hereinabove described method in that the user is not restricted to a specific number of surfboard blanks.

After receiving an order from an authorized customer for the custom surfboard blank in accordance with the custom surfboard blank design instruction stored with the assigned account number.

In this method, the end user customer customizes the surfboard blank with a rocker and the authorized customer fabrics the board in accordance with the modified blank customized by the end user customer.

### BRIEF DESCRIPTION OF THE DRAWINGS

The present invention may be more clearly understood with reference to the following detailed description in conjunction with the appended drawing, of which:

FIG. 1 is a schematic representation illustrating operations carried out by the web enabled system and method for designing, ordering, and delivery of a surfboard blank in accordance with the principles of the present invention by a non-authorized customer; and

FIG. 2 is a schematic representation illustrating operations carried out by the web enabled system and method for designing, ordering, and delivery of a surfboard blank in accordance with the principles of the present invention by an authorized customer.

### DETAILED DESCRIPTION

Referring to the figures in the accompanying drawings, the method and system for designing and manufacturing surfboard blanks will be described in greater detail.

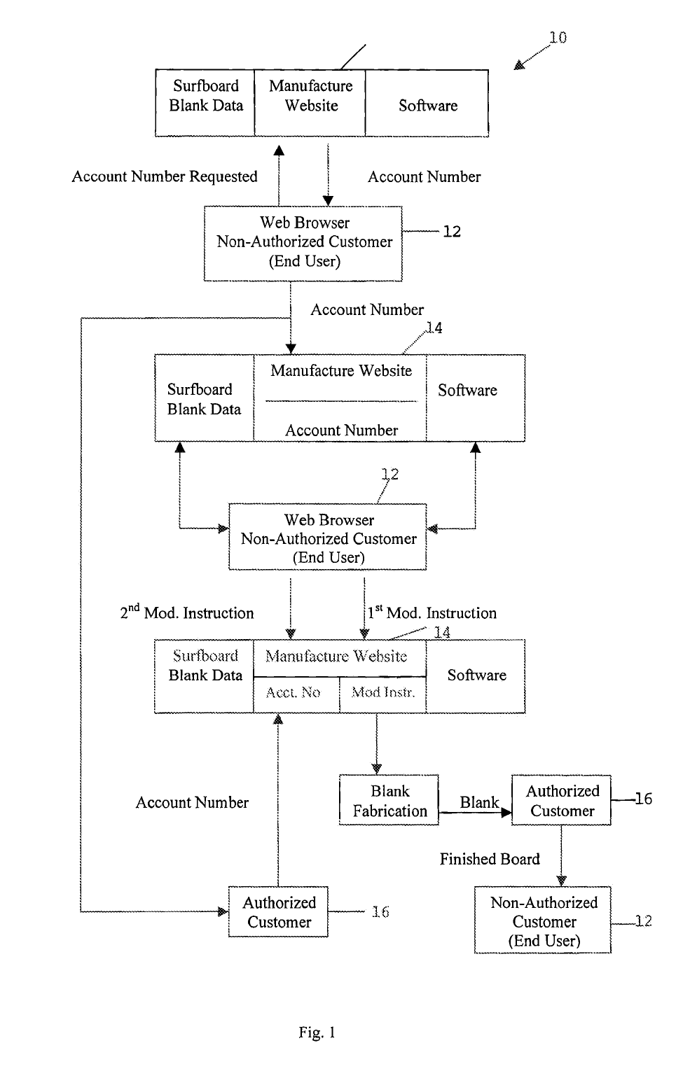

As shown in FIG. 1, the method and system 10 is implemented over a globally-based information network, such as the internet supporting the World Wide Web using hypertext transmission protocol (http.) and the hypertext marked up language (html.) well-known in the art.

As indicated in FIG. 1, an end user, but non-authorized customer, desiring a customized surfboard blank utilizes a web-enabled web browser 12 in order to visit the manufacturer's website 14 which is designed to support the specification, purchase, manufacture, and delivery of custom built surfboard blanks in accordance with the method of the present invention. The manufacturer's website 14 can be hosted upon any suitable internet (i.e., http) server running HTTP, with a TCP/IP link to an internet service provider (ISP) connected to the infrastructure of the internet. In accordance with the principles of the present invention, the manufacturer's website 14 includes surfboard blank data as well as software for modification and design of surfboard blanks.

As indicated in FIG. 1, the first step of the method of the present invention involves a request from the web browser 12 for an account number which is thereafter issued to the web browser 12 by the manufacturer's website 14.

This account number permits access to the surfboard design software.

Upon receipt of the account number by the manufacturer's website 14 from the web browser 12, surfboard blank data and software are provided to the web browser 12.

Utilizing the software, the web browser 12 provides modification instructions to the manufacturer's website 14 which is associated by the manufacturer's website 14 with the assigned account number. As indicated in FIG. 1, multiple instructions may be received by the manufacturer's website 14 by the web browser 12 all of which are associated and stored with the assigned account number.

Thereafter, the account number is communicated to an authorized customer 16 which is either a wholesaler or a surfboard finisher. This account number is then communicated by the authorized customer 16 to the manufacturer's website 14 in any manner for ordering of a surfboard blank through the manufacturer's website 14. Upon receipt of the order, a surfboard blank is fabricated and delivered to the authorized customer for finishing with the finished surfboard thereafter delivered to the non-authorized customer (end user).

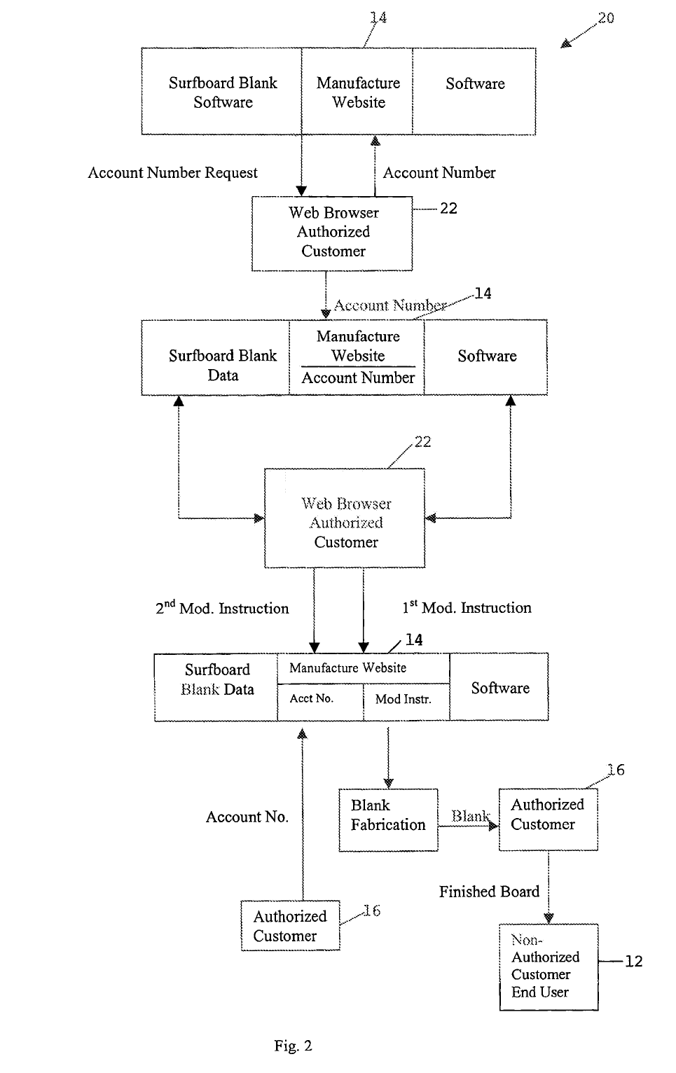

Alternatively, as illustrated in FIG. 2, the system 20 may be utilized directly by a web browser 22 of an authorized customer. In this instance, after a design of the blank by the authorized customer, an order is placed and utilizing the modification instruction a blank is fabricated and delivered to the authorized customer 16 for delivery to the end user.

In summary, the present invention is a method that enables an online user of the manufacturer's website to customize and modify the design of a surfboard blank to be purchased. The method entails both a method for customizing the design as well as a method for entering an order for the custom surfboard blank.

As hereinabove noted, a customer can log on to the website and thereby gain access to an online design tool. A basic blank design is chosen from a variety of sizes and shapes offered. These would include both surfboard blanks offered by the manufacturer and offered by various other surfboard blank manufacturers.

As hereinafter described, the method provides the customer with a multitude of ways for modifying the shape of the surfboard blank. When the customer is satisfied with the final design product, the modifications can be stored in a personal account with a unique serial number.

Thereafter, when the customer is ready to order the blank, such order can be effected by an email message, a fax message, or by telephone referring to the account number. Once the custom order is recognized, the file with the modifications is set to a fabricating wood shop for loading a file and machine codes into a CNC router which cuts the design of the stringer to the customer's specification that stringer is then fitted to a foam blank to provide the custom with the natural or custom rocker desired. These last recited steps are common in the art.

Various types of software may be provided.

For example, a program may be designed specifically just to modify the rocker of the board without affecting other changes in the board design. The rocker of a surfboard blank is the curve of the board that is evident when viewing the board's side profile, as hereinabove noted.

Specific rockers available for election by the customer would be those selected from a provided listed. Two basic groups of rockers may be provided with the first being a profile in view of all blanks with the design showing the natural rocker when an image loads in the screen. A second would be a set of rockers which would be those that match rockers sold by Clark Foam, a former industry leader, now defunct.

Modification of the available blanks could then be match the Clark rocker.

An alternative program may be provided includes an online CAD. CAD program that allows the customer to design a complete board and not just the basic blank that would be utilized to make the board. To start the design, the customers select one of the blanks and modify the various elements including the rails, rocker, nose, tail, depth, fins, and so forth. When a final design is effected, the modification can be saved to the account, as hereinabove noted.

With reference to design changes, it is the industry practice to call out adjustments to the nose or tail by indicating the deflection point and then indicating the lift, or drop, that should be applied to the nose holding the chose deflection point. For instance, it would not be uncommon for a customer to request that the rocker be changed utilizing a deflection point six inches back from the nose, lifting the nose one-quarter inch. Often to a more deflection points are chose with each being associated with a different lift or drop with the nose or tail respectively.

The software provided mimics this industry practice by enabling the user to choose deflection points and bend amounts utilizing drop down screens with which offer a variety of choices. Once a bend is complete the user can elect to bend the nose or tail again allowing for an infinite number of adjustments.

The software would also provide controls enabling the user to make adjustments to the curve of the profile using an x/y control access on points of the customers choosing. The profile is displayed includes certain “knots” along its length, top, and bottom of the profile and the user can click on these knots thus activating them and then utilize the x/y's positioning and controls to bend the board by moving the point to the right to the left upwardly or downwardly.

In addition, the software may provide a free hand function which enables the users to alter the profile of the chosen blank at will.

As indicated in the figures, at the time an authorized customer finishes a design, the customer may immediately order the blank or utilizing a conventional “shopping cart” approach for maintaining the order. The customer can save the finished blank design in the selected account which will hold an inventory of rocker designs for the customer. An authorized customer will then have the option of logging on at a later date, pulling up the respective custom rocker design that is in the customer's inventory of designs and place an order directly online.

As also indicated in the drawings, only authorized customers which include wholesalers and original equipment manufacturers are permitted to order directly from the manufacturer of the blanks. However, an individual may design a custom rocker who is not an authorize customer, as shown in FIG. 1. In this instance, an unauthorized customer, after designing the blank may purchase the blank through a listing of authorized distributors. Alternatively, the unauthorized user can transmit the account number to an authorized customer who then can order the blank.

Although there has been hereinabove described a specific method of designing a surfboard or the like in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. An internet enabled method for designing and ordering a surfboard blank, the method comprising:
hosting on a programmed internet information service, a website, capable of supporting an interactive procedure;
receiving from a web browser an account number request;
assigning an account number, in response to the request, for permitting access to surfboard design software;
upon receipt of the account number by the website, providing a listing of surfboard blanks offered for modification;
receiving modification instruction for a selected surfboard blank;
associating and storing the modification instruction for the selected surfboard blank with the assigned account number; and
thereafter receiving an order from an authorized customer for a surfboard blank modified in accordance with modification instruction stored with the account number.

2. The method according to claim 1 wherein the account number request is received from a non-authorized customer with a browser.

3. The method according to claim 2 further comprises communication of the account number from a non-authorized customer to the authorized customer.

4. The method according to claim 1 wherein providing a listing of surfboard blanks includes a listing of surfboard blanks of various surfboard blank manufacturers.

5. The method according to claim 1 further comprising receiving additional instruction for modifying the stored modification instruction and storing the further modified instructions with the assigned account number.

6. An internet enabled method for designing and ordering a surfboard blank, the method comprising:
hosting on a programmed internet information service, a website, capable of supporting an interactive procedure;
receiving from a web browser an account number request;
assigning an account number, in response to the request, for permitting access to surfboard design software;
upon receipt of the account number by the website, providing access to the surfboard design software;
receiving custom surfboard blank design instruction;
associating and storing the design instruction with the assigned account number; and
thereafter receiving an order from an authorized customer for the custom surfboard blank in accordance with the custom surfboard blank design instruction stored with the assigned account number.

7. The method according to claim 6 wherein providing a listing of surfboard blank includes a listing of surfboard blanks of various surfboard blank manufacturers.

8. The method according to claim 6 further comprising receiving additional instruction for modifying the stored modification instruction and storing the further modified instructions with the assigned account number.

9. The method according to claim 4 wherein the account number request is received from a non-authorized customer web browser.

10. The method according to claim 5 further comprising communicating of the account number for the non-authorized customer to the authorized customer.

11. An internet enabled method for designing and ordering a surfboard blank, the method comprising:
hosting on a programmed internet information service, a website, capable of supporting an interactive procedure;
receiving from a non-authorized customer web browser an account number request;
assigning an account number, in response to the request for permitting access to surfboard design software;
upon receipt of the account number by a website, providing a listing of surfboard blanks offered for modification;
receiving modification instruction for a selected surfboard blank;
associating and storing the modification instructions for the selected surfboard blank with the assigned account number; and
thereafter receiving an order from an authorized customer for a surfboard blank modified in accordance with modification instructions stored with the account number.

12. The method according to claim 11 wherein providing a listing of surfboard blank includes a listing of surfboard blanks of various surfboard blank manufacturers.

13. The method according to claim 11 further comprising receiving additional instruction for modifying the stored modification instruction and storing the further modified instructions with the assigned account number.

14. An internet enabled method for designing and ordering a surfboard blank, the method comprising:
hosting on a programmed internet information service, a website, capable of supporting an interactive procedure;
receiving from a web browser a request for surfboard design software;
providing, in response to the request, the surfboard design software;
providing a listing of surfboard blanks offered for modification;
thereafter receiving from the web browser an account number request;
assigning an account number in response to the account number request;
receiving modification instruction for a selected surfboard blank;
associating and storing the modification instruction for the selected surfboard blank with the assigned account number; and
thereafter receiving an order from an authorized customer for a surfboard blank modified in accordance with modification instruction stored with the account number.

15. The method according to claim 14 wherein the account number request is received from a non-authorized customer with browser.

16. The method according to claim 15 further comprises communication of the account number from a non-authorized customer to the authorized customer.

17. The method according to claim 14 wherein providing a listing of surfboard blank includes a listing of surfboard blanks of various surfboard blank manufacturers.

18. The method according to claim 14 further comprising receiving additional instruction for modifying the stored modification instruction and storing the further modified instructions with the assigned account number.
